(19) United States
(12) Patent Application Publication
(10) Pub. No.: US 2010/0190136 A1
(43) Pub. Date: Jul. 29, 2010

(54) STUD BLANK FOR A DENTAL IMPLANT

(76) Inventor: Hans-Arnulf Altmann, Oldenburg (DE)

Correspondence Address: WOOD, HERRON & EVANS, LLP, 2700 CAREW TOWER, 441 VINE STREET, CINCINNATI, OH, 45202, US

(21) Appl. No.: 12/527,921

(22) PCT Filed: Feb. 22, 2008
(86) PCT No.: PCT/EP2008/001391

§ 371 Date: Feb. 4, 2010

(30) Foreign Application Priority Data
Feb. 22, 2007 (DE) 102007009307.3
Feb. 22, 2007 (DE) 202007002797.4

(51) Int. Cl. A61C 8/00

(52) U.S. Cl. 433/173

(57) ABSTRACT

The invention relates to a stud blank for a dental implant comprising an implant member that is to be inserted into a jaw. The stud blank includes an outer contour formed by at least partly spatially overlapping the outer contour of at least one first individual stud which encloses a first angle of inclination relative to a longitudinal axis of the implant member and the outer contour of a second individual stud that encloses a second angle of inclination relative to the longitudinal axis of the implant member.

### TECHNICAL FIELD

The invention relates to a stud blank for a dental implant comprising an implant member to be inserted into a jaw.

### BACKGROUND

Dental jaw implants are widely known, and serve to anchor dental prostheses in the jaw of a patient. To that end, such implants have an implant member, which frequently has threading for screwing into the jaw, as well as a stud to which the dental prosthesis is attachable.

In order to be able to use such implants under different utilization conditions, their studs must either be oriented in a straight line with a longitudinal axis of the implant member or must be tilted at a certain angle of inclination relative to that axis, so that it is possible to screw the implant member obliquely into the jaw—for example when there is too little space available in the vertical direction—and yet to obtain a vertically oriented stud.

However, this requires that a plurality of implants with studs inclined at different angles relative to the longitudinal axis of the implant member be kept in inventory or produced.

The object of the present invention is therefore to provide a stud blank for a dental implant of the type named at the beginning, from which a stud with a defined angle of inclination can be formed.

### SUMMARY

The invention provides a stud blank with an external contour which is formed by an at least partial spatial overlaying of the external contour of at least a first individual stud, which includes a first angle of inclination relative to a longitudinal axis of the implant member, and the external contour of a second individual stud, which includes a second angle of inclination relative to the longitudinal axis of the implant member.

The measures according to the invention enable a stud blank to be created in an advantageous manner, which is distinguished by the fact that through a simple removal of material at least one stud can be formed from it which runs at either the first or the second angle of inclination relative to the longitudinal axis of the implant member. It is therefore possible for the attending dentist or dental technician to work on the stud blank on site in a simple manner, so that the stud is tilted at the desired inclination relative to the longitudinal axis of the implant member.

An advantageous refinement of the invention provides for the external contour of the stud blank to be formed by an at least partial spatial overlaying of the external contours of a plurality of individual studs, whose angles of inclination lie in the range bounded by the first and second angles of inclination. The measure according to the invention has the advantage that its use is not limited to forming from the stud blank not only one stud, which is inclined relative to the longitudinal axis of the implant member either at the first angle of inclination or at the second angle of inclination. Rather, the measures according to the invention allow the formation from the stud blank according to the invention of a stud with a plurality of different angles of inclination.

Another advantageous refinement of the invention provides for the external contour of the stud blank according to the invention to be determined in such a way that a twisting motion of the first individual stud running at the first angle of inclination is transmitted to the second individual stud running at the second angle of inclination. Such a measure has the advantage that by simple removal of material from material areas of the stud blank according to the invention a stud can be created with an angle of inclination that lies between the first and the second angles of inclination.

Another advantageous refinement of the invention provides that the first angle of inclination is essentially 0°. This measure according to the invention thus makes it possible advantageously in an especially simple way to create from the stud blank either a stud that runs in a straight line relative to the longitudinal axis of the implant member, or a stud that is situated at an angle thereto.

Another advantageous refinement of the invention provides that the stud blank and the implant member are designed in a single piece, which has the advantage of a compact implant with high strength.

Another advantageous refinement of the invention provides that the stud blank and the implant member are designed in two pieces and are connectable to each other, resulting in easier insertion of the implant member.

If the stud blank and the implant member are executed as separate elements and are connectable to each other, then according to another advantageous refinement of the invention it is preferred that the connection between the stud blank and the implant member be protected against twisting, which is preferably realized by means of a non-rotationally-symmetrical plug-in connection.

Additional advantageous refinements are the subject of the subordinate claims.

### BRIEF DESCRIPTION OF THE DRAWINGS

Additional advantages and details of the invention can be seen from the exemplary embodiment described on the basis of the drawings. The figures show the following:

FIG. 1 is a perspective oblique view of an exemplary embodiment of a stud blank for a dental implant.

FIG. 2 is a perspective side view of the exemplary embodiment in FIG. 1.

FIG. 3 is a cross section through the exemplary embodiment in FIG. 1 along a line III-III of FIG. 1.

FIG. 4 is a top view of the exemplary embodiment of FIG. 1.

FIG. 5 is a cross section through the exemplary embodiment of FIG. 1 connected to an implant member.

### DETAILED DESCRIPTION

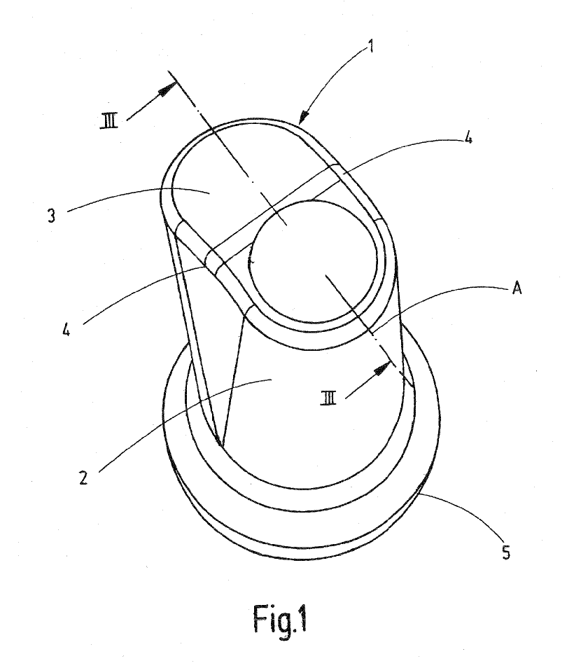

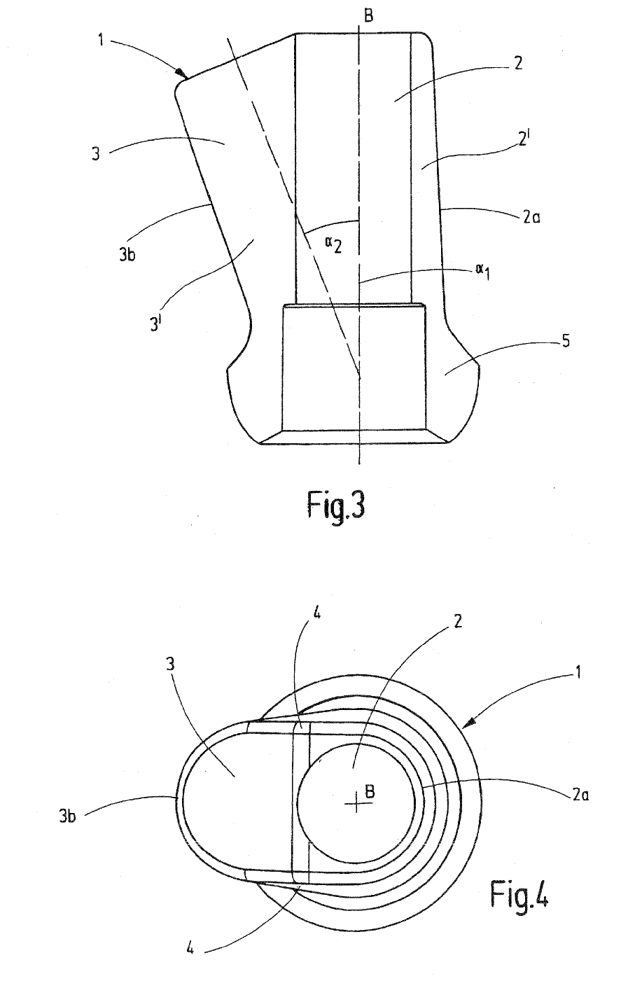

FIGS. 1 and 2 or 3 show, in perspective or cross sectional depiction, an exemplary embodiment of a stud blank 1 for a dental implant, which is connectable to an implant member 6 depicted in FIG. 5, which may be screwed into a jaw of a patient. The stud blank 1 has an external contour A, which is defined by overlaying an external contour 2′ of a first individual stud 2 and an external contour 3′ of a second individual stud 3. The first individual stud 2 is tilted at a first angle of inclination al relative to a longitudinal axis B of implant member 6. In the case shown here, the first angle of inclination is α1=0°. The second individual stud 3 runs at a second angle of inclination α2 relative to the longitudinal axis B; in the case shown here, the second angle of inclination is α2=25°. The forenamed values of α1 and α2 have only exemplary character, however. It is also possible to provide a smaller or larger angle of inclination α1 or α2. The external contour A of stud blank 1 is thus defined by an overlaying of the external contours 2′ and 3′ of the two individual studs 2 and 3.

In the case shown here, the right-side area A′ of external contour A in FIGS. 1 through 3 is defined by a corresponding area 2a of the external contour 2′ of first individual stud 2, and the left-side area A″ of external contour A of stud blank 1 in FIGS. 1 through 3 is defined by the corresponding area 3b of the external contour 3′ of second individual stud 3.

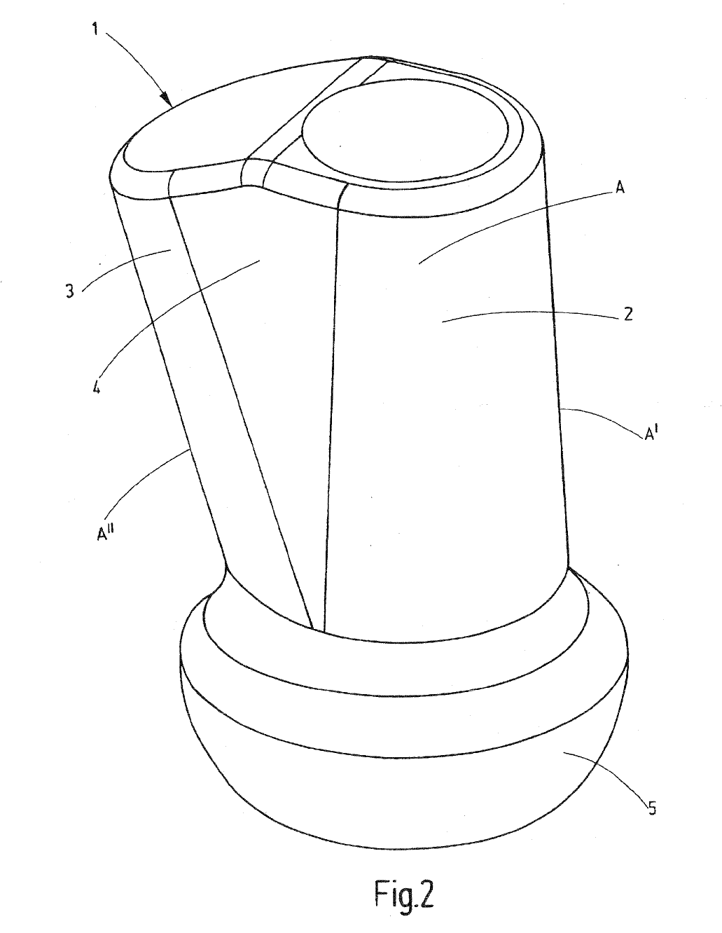

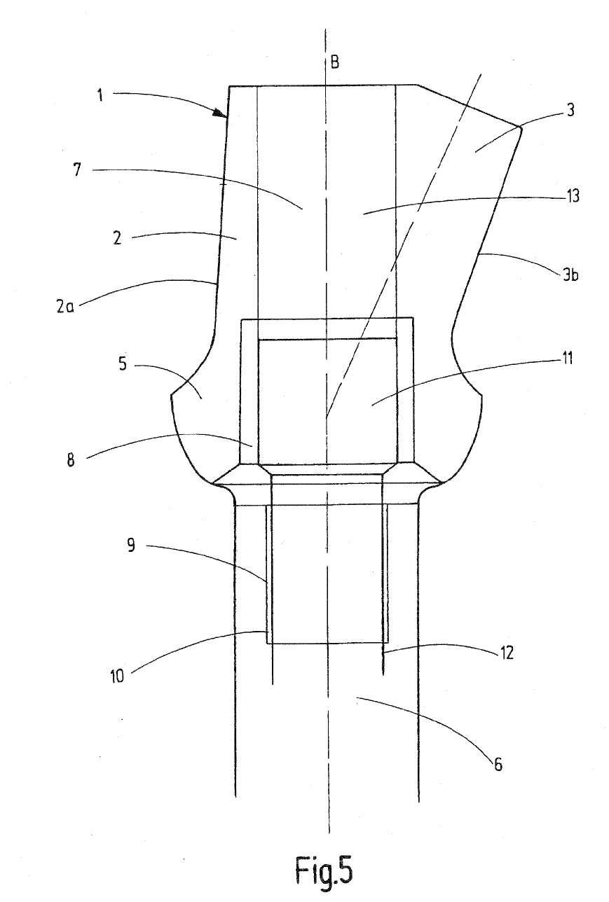

Now in order to be able to produce either the first individual stud 2 with an angle of inclination α1=0° or the second individual stud 3 with an angle of inclination α2=25° from stud blank 1 not only through a corresponding removal of material—as will be described in greater detail later—, it is preferred that—as can be seen from FIGS. 1 and 2 and in particular from FIG. 4—the external contour A of stud blank 1 be defined so that it is essentially transmitted by twisting the first individual stud by the differential angle α=α2−α1 into the second individual stud 3. In FIG. 4 the two fictitious contours of the individual studs 2 and 3 are represented by the dotted lines K1 and K2. It can be seen from this FIG. 4 that when the design principle described above is used—rotating individual stud 2 into individual stud 3—an area 4 is formed between the contours of the two fictitious individual studs 2 and 3 which results from the rotation described above. Such a measure has the advantage that it is thereby not only possible optionally to form an individual stud 2 and an individual stud 3 from stud blank 1, but that it is possible to form an individual stud with essentially any desired angle of inclination, which lies between the two boundary angles of inclination α1 and α2, by performing an appropriate removal of material, for example by milling or grinding, and thus by means of the tools that are usually present in a dentist's office or dental laboratory.

Now if for example a non-angled stud 1′ is needed, the material is removed from stud blank 1 that is in excess of the volume of the first individual stud 2, and thus of the desired stud 1′.

On the other hand, if the desired stud 1′ is to have a longitudinal axis that is tilted relative to the longitudinal axis B of implant member 6, then the material is removed from stud blank 1 that is in excess of the shape of the desired angled stud 1′.

It is possible in this way to produce studs 1′ with an angle of inclination—in this exemplary embodiment—between 0°, which corresponds to the angle of inclination α1 of the first individual stud 2, and 25°, which corresponds to the angle of inclination α2 of the second individual stud.

As can be seen in particular from FIG. 5, stud blank 1 still has a gingival circumferential step 5, which displaces the gum when stud blank 1 is placed on the implant member 6. It may take various shapes, known to the person skilled in the art, and in cooperation with the implant member 6 serves to shape the gum and bring it into optimal contact with the stud blank 1

The stud blank 1 described in this exemplary embodiment has a bipartite form, and is made up, as depicted in FIG. 5, of an element 7 mounted on top and a base element 8, which will preferably not be processed. Preferably, the material of the top-mounted element 7 here is zirconium oxide, and that of the base element 8 is titanium; other materials are of course also possible, for example from the realm of plastics, metals or ceramics. The top-mounted element 7 can be connected to the base element 8 in a manner known to the person skilled in the art, for example by cementing, welding or shrinking.

The stud blank 1 or the base element 8 is connected to the implant member 6 depicted here by means of a projection 9 of the base element 8, which is inserted into a corresponding recess 10 in the implant member 6. Preferably, this connection is secured against twisting, by having for example a non-rotationally-symmetrical hexagonal cross section. Other forms of recess 10 and projection 9, such as polygonal cross sections, are of course also possible.

Stud blank 1 or base element 8 is fixed on implant member 6 by means of a screw 11, which may be screwed into female threading 12 in implant member 6. To this end, stud blank 1 has a feed-through 13, both in its top-mounted element 7 and in base element 8, through which the screw 11 can both be introduced and can also be screwed into the female threading 12 in implant member 6 by means of a suitable tool.

In contrast to the stud blank 1 described here, made up of a base element 8 and a top-mounted element 7, a single-piece stud blank 1 is of course also-possible. Likewise, instead of an implant member 6 separate from stud blank 1, stud blank 1 and implant member 6 may also be produced in a single piece, which is accompanied by the advantage of greater strength, since for example a threaded connection that would weaken the cross section would be eliminated. On the other hand, dividing them into two parts makes it easier to insert the implant member 6 into the jaw of the patient, so that the choice between a single-piece or a two-piece implant must be made depending on the desired advantages to be achieved.

1. Stud blank for a dental implant, having an implant member (6) for insertion into a jaw, characterized in that the stud blank (1) has an external contour that is formed by an at least partial spatial overlaying of the external contour of at least one first individual stud (2), which includes a first angle of inclination (α1) relative to a longitudinal axis (B) of the implant member, and of the external contour of a second individual stud (3), which includes a second angle of inclination (α2) relative to the longitudinal axis (B) of the implant member (6).

2. The stud blank according to claim 1, characterized in that the external contour (A) of the stud blank (1) is formed by an at least partial spatial overlaying of the external contours of a plurality of individual studs (2, 3), whose angles of inclination lie in the range limited by the first and second angles of inclination (α1, α2).

3. The stud blank according to one of the preceding claims, characterized in that the external contour (A) of the stud blank (1) is defined by rotating the first individual stud (2) around a differential angle (α) between the first angle of inclination (α1) and the second angle of inclination (α2).

4. The stud blank according to one of the preceding claims, characterized in that the first angle of inclination (α1) is zero degrees.

5. The stud blank according to one of the preceding claims, characterized in that the stud blank (1) is made up of at least a base element (6) and a top-mounted element (7).

6. The stud blank according to one of the preceding claims, characterized in that the stud blank (1) and/or the top-mounted element (7) has zirconium as a component.

7. The stud blank according to one of the preceding claims, characterized in that the base element (6) has titanium as a component.

8. A dental implant having an implant member for insertion into a jaw, characterized by a stud blank according to one of the preceding claims 1 through 7.

9. The implant according to claim 8, characterized in that the stud blank (1) and the implant member (6) are designed in a single piece.

10. The implant according to claim 9, characterized in that the stud blank (1) is connectable to implant member (6).

11. The implant according to claim 10, characterized in that the connection between the stud blank (1) and the implant member (6) is secured against twisting.

12. The implant according to claim 11, characterized in that the stud blank (1) and the implant member (6) are connectable by a non-rotationally-symmetrical plug-in connection.

13. The implant according to one of claims 9 through 12, characterized in that the stud blank (1) has a feed-through (13), into which a screw (11) may be introduced to connect the stud blank (1) with the implant member (6).

14. The implant according to one of claims 9 through 13, characterized in that the stud blank (1) has a projection (9) which may be inserted into a recess (10) in the implant member (6).

15. The implant according to claim 14, characterized in that the base element (6) and the top-mounted element (7) are cemented, welded or shrunk together.
